(19) United States
(12) Patent Application Publication
(10) Pub. No.: US 2006/0164465 A1
(43) Pub. Date: Jul. 27, 2006

(54) Receptacle for colored marking material container

(76) Inventors: Charles R. Steinmetz, Corvallis, OR (US); Curt Gonzales, Corvallis, OR (US); Lisa M. Hanson, Vancouver, WA (US)

Correspondence Address: HEWLETT-PACKARD COMPANY;Intellectual Property Administration, P. O. Box 272400, Fort Collins, CO, 80527-2400, US

(21) Appl. No.: 11/040,206

(22) Filed: Jan. 21, 2005

(51) Int. Cl. B41J 2/21

(52) U.S. Cl. 347/43

(57) ABSTRACT

In one embodiment, a receptacle for a container of printer marking material includes a colored material forming a surface conforming generally to a surface on a container of colored printer marking material that is not black. The colored material has substantially the same color as the marking material.

### BACKGROUND

Some inkjet printing systems utilize replaceable ink supplies, which may be integral with the printheads (replaceable print cartridges, for example) or separate from the printheads (ink tanks, for example). When the printheads are integral to the ink supplies, a print cartridge is replaced each time a new ink supply is needed. When the printheads are separate from the ink supply, only the ink tank is replaced each time a new ink supply is needed. Some inkjet printers now use six different colored individual replaceable ink supplies that fit into six corresponding receptacles in the printer. Installing these new many colored ink supplies can be significantly more complex for many users than installing ink supplies in the more familiar two cartridge system which uses just one black cartridge and one multi-colored cartridge.

### DRAWINGS

FIG. 1 illustrates one example of a printer in which embodiments of the invention maybe implemented.

FIG. 2 illustrates one example of a group of colored ink tanks and matching colored receptacles.

FIG. 3 is a detail view of one of the ink tanks in FIG. 2 and the corresponding receptacle.

### DESCRIPTION

Embodiments of the present invention were developed in an effort to make it easier for a user to correctly install a colored ink supply in the corresponding receptacle in the printer. Some embodiments of the invention, therefore, will be described with reference to ink supply containers and inkjet printing. Embodiments of the invention, however, are not limited to use in inkjet printing or with ink. Rather, embodiments of the invention may be used with other printer marking materials and in other printing applications or environments. The exemplary embodiments shown in the figures and described below illustrate but do not limit the invention. Other forms, details, and embodiments may be made and implemented. Hence, the following description should not be construed to limit the scope of the invention, which is defined in the claims that follow the description.

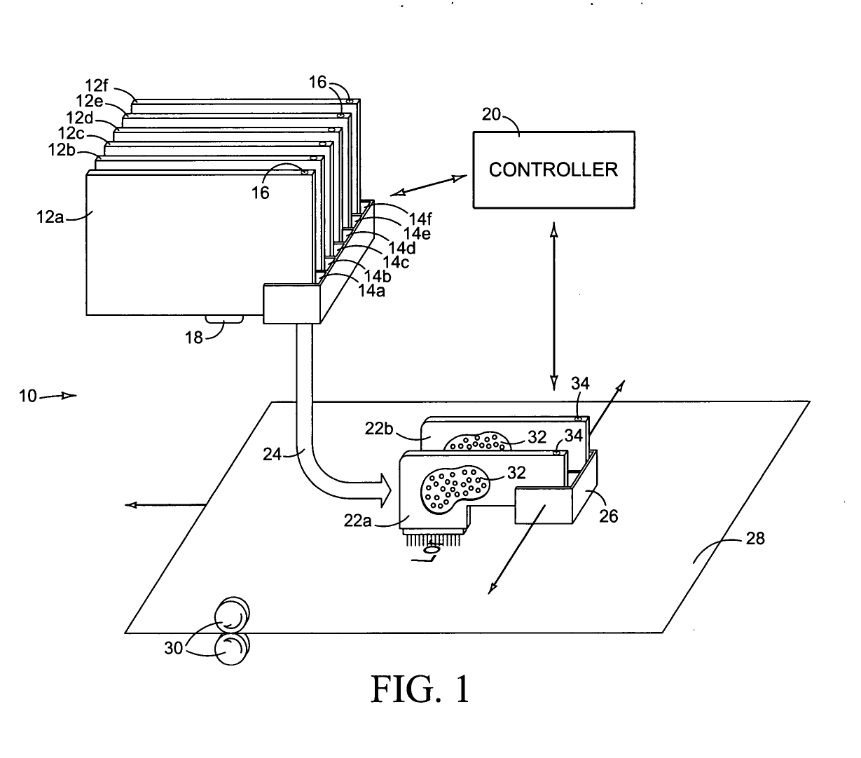

FIG. 1 illustrates one example of a printer 10 in which embodiments of the invention may be implemented. Referring to FIG. 1, printer 10 includes replaceable ink supplies 12a-12f each containing a different color ink. A typical six color configuration might include, for example, yellow, magenta, light magenta, cyan, light cyan and black. Each ink supply 12a-12f fits into a corresponding receptacle 14a-14f. Each ink supply 12a-12f may retain ink in a capillary material such as foam or fibers or the supply may contain free ink. Each ink supply 12a-12f may include a vent 16 to maintain an appropriate pressure relationship between the interior of the supply and the ambient air, or another suitable pressure regulating mechanism. Other configurations of ink supplies are possible, including pressurized supplies.

Each ink supply 12a-12f may also include an integral memory 18 storing information pertaining to the ink supply and the printer. Memory 18 may include non-alterable memory as well as alterable/programmable memory that may be altered/programmed by, for example, the printer controller 20 or a host device connected to printer 10. Supply memory 18 may communicate with printer controller 20 or another device through electrical contacts on the supply when the supply is installed in the corresponding receptacle or through a wireless data link.

Ink from each supply 12a-12f is supplied to printheads 22a and 22b through an ink delivery system 24. Ink delivery system 24 represents generally any suitable structure or mechanism for getting ink from the ink supplies 12a-12f to printheads 22a and 22b. For off-axis ink supplies, ink delivery system 24 may utilize, for example, “trailing tubes” in which flexible tubes connect stationary ink supplies 12a-12f to scanning printheads 22a and 22b, or intermittent “take-a-sip” fluidic connections between the ink supplies 12a-12f and printheads 22a and 22b. For integrated print cartridges in which the ink supply and the printhead are housed in the same container, ink delivery system 24 may simply consist of passages within the container through which ink passes from the supply to the printhead. Ink delivery system 24 may also include one or more pressure regulating devices configured to help insure the reliable delivery of ink to the printheads. Ink delivery system 24 may provide ink to the printheads on a continuous basis or intermittently to refill the printheads during non-printing intervals.

Printer 10 may include a single printhead or multiple printheads (two printheads 22a and 22b are shown). Each printhead may include a single array of ink ejection nozzles for printing a single color, or multiple arrays each for printing a different color. For example, each printhead 22a and 22b in FIG. 1 may include three arrays of ink ejection orifices for printing three different colors so that each printhead prints three of the six colors from ink supplies 12a-12f. Possible configurations range from a single printhead that prints all of the colors to a series of individual printheads that each print only one color. In a scanning printhead printer, such as printer 10 in FIG. 1, printheads 22a and 22b are carried by a scanning carriage 26 that is driven back and forth across a sheet of paper or another print medium 28. A print media transport mechanism, represented by rollers 30 in FIG. 1, advances print medium 28 past printheads 22a and 22b. Again, for a scanning printhead printer, media transport 30 may advance print medium 28 incrementally past printheads 22a and 22b, stopping as each swath is printed and then advancing print medium 28 for printing the next swath. In a stationary printhead printer, in which one or more stationary printheads span the width of the print medium, the media transport may advance the print medium continuously past the stationary printheads.

A typical thermal inkjet printhead 22a and 22b, for example, includes a nozzle plate arrayed with ink ejection nozzles and firing resistors formed on an integrated circuit chip positioned behind the ink ejection nozzles. The ink ejection nozzles are usually arrayed in columns along the nozzle plate. A flexible circuit carries electrical traces from external contact pads to the firing resistors. Each printhead is electrically connected to printer controller 20 through the contact pads. In operation, printer controller 20 selectively energizes the firing resistors through the signal traces. When a firing resistor is energized, ink in a vaporization chamber next to a resistor is vaporized, ejecting a drop of ink through a nozzle on to the print medium 28. The vaporization chamber then refills with ink in preparation for the next ejection.

Each printhead 22a and 22b also often includes one or more mechanisms for controlling ink backpressure, so that ink does not “drool” from the ink ejection nozzles. For example, in FIG. 1, printheads 22a and 22b include a capillary material 32 filling a local ink reservoir and a vent 34.

Controller 20 usually controls all aspects of printer 10. Controller 20 receives print data from a computer or other host device and processes that data into printer control information and image data. Controller 20 controls the movement of carriage 26 and media transport 30. As noted above, controller 20 is electrically connected to printheads 22a and 22b to energize the firing resistors to eject ink drops on to print medium 28. By coordinating the relative position of printheads 22a and 22b and medium 28 with the ejection of ink drops, controller 20 produces the desired image on medium 28 according to the print data received from the host device. Controller 20 may also communicate with and control certain functions in ink tanks 12a-12f through electrical contacts in each receptacle 14a-14f.

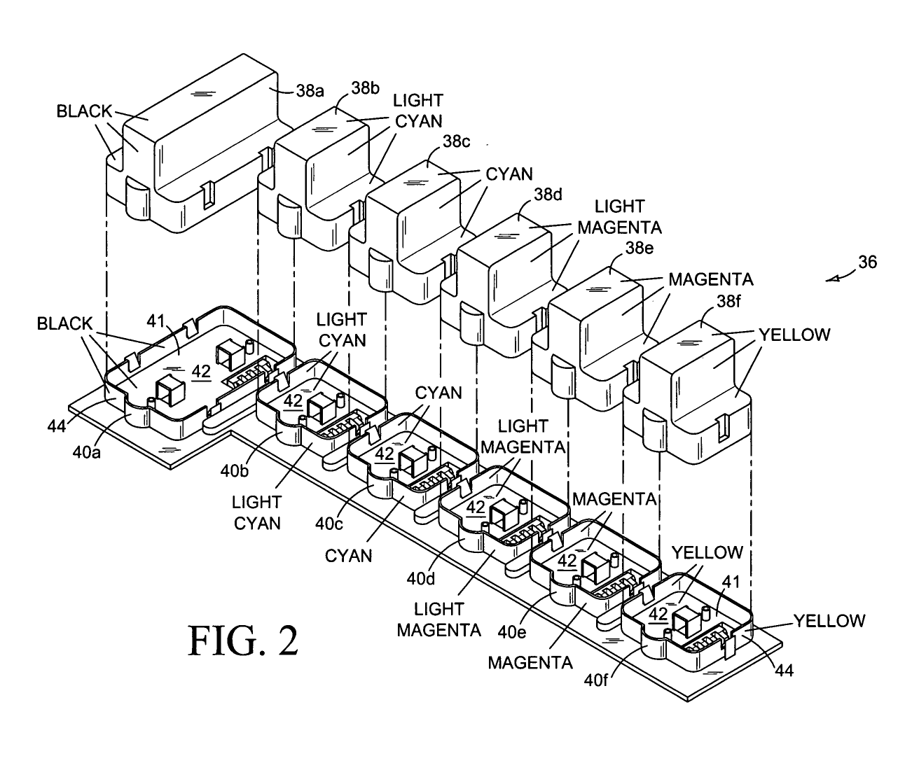

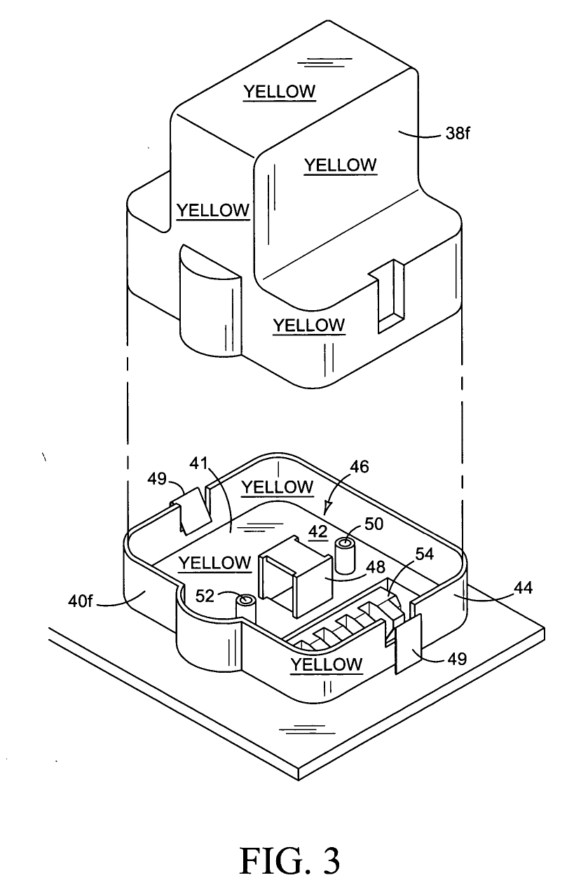

FIG. 2 illustrates one example of a group 36 of individual colored ink tanks 38a-38f and corresponding receptacles 40a-40f such as might be used for tanks 12a-12f and receptacles 14a-14f in the printer 10 of FIG. 1. FIG. 3 is a detail view of yellow colored tank 38f and receptacle 40f of FIG. 2. Referring to FIG. 2, group 36 includes a black colored ink tank 38a for black ink, a light cyan colored ink tank 38b for light cyan ink, a cyan colored ink tank 38c for cyan ink, a light magenta colored ink tank 38d for light magenta ink, a magenta colored ink tank 38e for magenta ink, and a yellow colored ink tank 38f for yellow ink. The outside of each ink tank 38a-38f, or at least a substantial portion of the outside of the tank, is formed from a colored material that is substantially the same color as the ink in the tank. Inkjet printer ink tanks are usually formed of molded plastic. Such tanks, therefore, can be molded from pigmented or otherwise colored plastic to form colored ink tanks 38a-38f. Alternatively, the outside of each ink tank 38a-38f may be painted or otherwise coated with a coloring that matches the color of the ink contained in the tank. Colored ink tanks are disclosed in a co-pending, co-owned U.S. patent application Ser. No. 10/631,182 filed Jul. 31, 2003, titled Replaceable Printing Consumable With Features Facilitating Intuitive Installation By A User, which is incorporated herein by reference in its entirety.

Referring now also to FIG. 3, each ink tank 38a-38f fits into a corresponding receptacle 40a-40f. In the embodiment shown in FIGS. 2 and 3, each receptacle 40a-40f includes a base 41 that presents a substantially flat surface 42 facing a mating surface (not shown) on the ink tank. A wall 44 around surface 42 conforms generally to the outer perimeter of the ink tank. Each receptacle 40a-40f also includes an interface package 46 that contains features for the interconnection between the ink tank and the receptacle. Interface package 46 includes an alignment structure 48 and spring clips 49 that help hold the ink tank securely and in the proper position in the receptacle, an air vent 50 and ink port 52 that allow ink to flow from the ink tank, and electrical contacts 54. Each ink tank 38a-38f includes an interface package (not shown) with complementary interconnection features. Examples of an ink tank interface package are described in the '182 application noted above. The interface package 46 shown in FIGS. 2 and 3 is just one example of a suitable group of mechanical, fluid and electrical ink tank interconnections for each receptacle 40a-40f. Other suitable interconnection features and configurations are possible.

Base 41 or wall 44 of each receptacle 40a-40f, or both, are formed from or coated with a colored material that is substantially the same color as the ink contained in the corresponding ink tank 38a-38f. The structural features of receptacles, such as base 41 and wall 44, are usually formed of molded plastic. Such features, therefore, can be molded from pigmented or otherwise colored plastic to form a colored surface 42 or a colored wall 44 or both a colored surface 42 and a colored wall 44. Alternatively, base 41 or wall 44, or both, may be painted or otherwise coated with a coloring that matches the color of the ink contained in the corresponding ink tank. A label covering substantially all of the exposed parts of surface 42 or substantially all of the inside or outside of wall 44, for example, may provide a suitable color coating alternative to painting.

Conventional ink supply receptacles use labels with words or a small color patch, or both, to communicate the appropriate color. Coloring a major feature of the receptacle, such as surface 42 or wall 44 in FIGS. 2 and 3, much more clearly communicates the color to the user than does conventional labeling, and greatly simplifies the user's task of installing the correct ink supply into the receptacle, especially where there are numerous individual ink supplies that must be fitted into corresponding individual receptacles.

As noted at the beginning of this Description, the exemplary embodiments shown in the figures and described above illustrate but do not limit the invention. Other forms, details, and embodiments may be made and implemented. Therefore, the foregoing description should not be construed to limit the scope of the invention, which is defined in the following claims.

What is claimed is:

1. A receptacle for a container of printer marking material, comprising a colored material forming a surface conforming generally to a surface on a container of colored printer marking material that is not black, the colored material having substantially the same color as the marking material.

2. The receptacle of claim 1, further comprising a marking material interconnection through which marking material may be received from a container.

3. The receptacle of claim 1, wherein the surface comprises a substantially flat surface facing a mating surface on a container when the container is installed in the receptacle.

4. The receptacle of claim 1, wherein the surface comprises a projecting surface conforming generally to an outer perimeter of a container when the container is installed in the receptacle.

5. The receptacle of claim 1, wherein the colored material forming a surface comprises a coating on an underlying structure.

6. A receptacle for a container of colored printer marking material that is not black, comprising:
a surface conforming generally to a surface on the container;
a marking material interconnection through which marking material may be received from the container;
an alignment structure configured to correctly position the container in the receptacle; and
one or more of the surface, the marking material interconnection and the alignment structure comprising a colored material having substantially the same color as marking material in the container.

7. The receptacle of claim 6, further comprising an electrical interconnection through which electrical signals may be transmitted to or received from the container.

8. A receptacle for a printer ink tank containing colored ink that is not black, comprising:
a base formed from or coated with a colored material having substantially the same color as the ink;
an ink port on the base through which ink may be received from the tank; and
an alignment structure on the base configured to correctly position the tank in the receptacle.

9. The receptacle of claim 8, further comprising a wall around at least part of the base, the wall conforming generally to at least part of an outer perimeter of the tank and the wall formed from or coated with a colored material having substantially the same color as the ink.

10. The receptacle of claim 8, further comprising an electrical interconnection on the base through which electrical signals may be transmitted to or received from the tank.

11. A receptacle for an inkjet printer ink tank containing colored ink that is not black, comprising:
a wall conforming generally to at least part of an outer perimeter of the tank, the wall formed from or coated with a colored material having substantially the same color as the ink;
an ink port within a perimeter of the wall through which ink may be received from the tank; and
an alignment structure within the perimeter of the wall configured to correctly position the tank in the receptacle.

12. A group of receptacles for containers of printer marking material, the group comprising a plurality of receptacles each configured to receive a corresponding one of a plurality of containers of different colored printer marking material, each receptacle comprising a colored material having substantially the same color as the colored printer marking material in a container corresponding to the receptacle and each receptacle.

13. The group of claim 12, wherein each receptacle includes a marking material interconnection through which marking material may be received from a container.

14. A group of printer marking material containers and corresponding receptacles for use in a color printer, the group comprising:
a plurality of containers each for containing a corresponding different colored printer marking material and each container comprising a colored material having substantially the same color as the colored printer marking material corresponding to the container; and
a plurality of receptacles each configured to receive a corresponding one of the containers, each receptacle comprising a colored material having substantially the same color as the corresponding colored printer marking material and each receptacle including a marking material interconnection through which marking material may be received from a container.

15. An inkjet printer, comprising:
a printhead;
a print media transport configured to move print media past the printhead;
an electronic controller operative to control operation of the printhead and the print media transport;
a plurality of containers each for containing a corresponding different colored ink, each container operatively connected to the printhead and each container comprising a colored material having substantially the same color as the colored ink corresponding to the container; and
a plurality of receptacles each configured to receive a corresponding one of the containers, each receptacle comprising a colored material having substantially the same color as the corresponding colored ink and each receptacle including an ink port through which ink may be received from a container.

16. An inkjet printer, comprising:
a first printhead and a second printhead;
a print media transport configured to move print media past the printheads;
an electronic controller operative to control operation of the printheads and the print media transport;
a first container of a first colored ink operatively connected to the first printhead, the first container comprising a colored material having substantially the same color as the first colored ink;
a first receptacle configured to receive the first container, the first receptacle comprising a colored material having substantially the same color as the first colored ink;
a second container for a second colored ink operatively connected to the second printhead, the second container comprising a colored material having substantially the same color as the second colored ink; and
a second receptacle configured to receive the second container, the second receptacle comprising a colored material having substantially the same color as the second colored ink.

17. The printer of claim 16, wherein:
the first printhead and the first container are integrated into a first print cartridge and the first receptacle is configured to receive the first print cartridge; and
the second printhead and the second container are integrated into a second print cartridge and the second receptacle is configured to receive the second print cartridge.

18. A printer, comprising:
a means for depositing a marking material on to a print medium;
a container of colored printer marking material that is not black, the container operatively connected to the depositing means; and
a receptacle for the container, the receptacle comprising a colored material forming a surface conforming generally to a surface on the container, the colored material having substantially the same color as the marking material.
